(19) United States
(12) Patent Application Publication
(10) Pub. No.: US 2012/0050768 A1
(43) Pub. Date: Mar. 1, 2012

(54) COLOR IMAGE FORMING APPARATUS AND CONTROL BOARD INCLUDED IN THE SAME

(75) Inventors: Yoon Seop EOM, Suwon-si (KR); Chun Sub Ryu, Yongin-si (KR)

(73) Assignee: Samsung Electronics Co., Ltd., Suwon-si (KR)

(21) Appl. No.: 13/219,861

(22) Filed: Aug. 29, 2011

(30) Foreign Application Priority Data
Aug. 30, 2010 (KR) 10-2010-0084432
Aug. 24, 2011 (KR) 10-2011-0084410

(51) Int. Cl. G06K 15/02

(52) U.S. Cl. 358/1.9

(57) ABSTRACT

A color image forming apparatus and a control board included in the same are provided. The functions of an image processing unit and an engine controller are integrally implemented by a single processor on a control board. Thus, it is possible to eliminate circuit elements such as circuits associated with an interface between the image processing unit and the engine controller, which are needed when the image processing unit and the engine controller are separated. Accordingly, it is possible to efficiently design the control board and to reduce manufacturing costs.

### CROSS-REFERENCE TO RELATED APPLICATIONS

This application claims priority under 35 U.S.C. §119 from Korean Patent Application No. 2010-0084432, filed on Aug. 30, 2010 and Korean Patent Application No. 2011-84410, filed on Aug. 24, 2011 in the Korean Intellectual Property Office, the disclosure of which is incorporated herein in its entirety by reference.

### BACKGROUND OF THE INVENTION

1. Field of the Invention

Embodiments of the present general inventive concepts relate to a color image forming apparatus and a control board included in the same, wherein an engine mechanism converts print data into image data and performs a print operation based on the image data.

2. Description of the Related Art

A color image forming apparatus generally scans light to a photosensitive drum charged to a specific potential to form electrostatic latent images, develops the electrostatic latent images using developers of desired colors and then transfers and fixes the developed developer images to a sheet of paper to form color images.

The color image forming apparatus includes an image processing unit, an engine controller, and an engine mechanism.

The image processing unit includes a read-only memory (ROM) to store various application programs and a control program to drive the image processing unit, a random-access memory (RAM) to temporarily store data received from a host computer and various other data, an engine interface unit to interface signals with the engine controller, a computer interface unit to interface signals with the host computer, and a central processing unit (CPU) to control overall operations of the image processing unit according to the control program stored in the ROM.

A CPU in the image processing unit generates a display list to convert print data transmitted from the host computer through the computer interface unit into image data and stores the image data after color conversion into cyan magenta yellow black (CMYK). The CPU converts data stored in the RAM into image data in a bitmap format and transmits the generated image data to the engine controller through the engine interface unit.

The engine controller includes a CPU which is a processor to control operations of the engine mechanism under control of the image processing unit, a ROM to store various control programs, a RAM to temporarily store data produced as the programs are executed, and an engine interface unit that is connected between the CPU of the engine controller and the engine interface unit to interface input and output signals.

The CPU of the engine controller controls a paper feed unit to pick up a sheet of paper upon receiving a print start command from the image processing unit through the engine interface unit. Upon determining that the sheet of paper has reached a preset reference position based on sensing results from a sensing unit, the CPU transmits a paging synchronization signal Psync, which indicates start of printing, to the image processing unit through the engine interface unit. Upon receiving bitmap data from the image processing unit in response to the paging synchronization signal Psync, the CPU controls the engine mechanism to perform a print operation for the received bitmap data.

The engine mechanism performs a print operation under control of the CPU of the engine controller. The engine mechanism includes a paper feed unit, a Laser Scanning Unit (LSU) which is an exposure unit, a developing unit, a transfer unit, a fixing unit, a sensing unit, and the like.

The control boards (e.g., Printed Circuit Boards (PCBs)) of the image processing unit and the engine controller in the conventional image processing unit are provided with respective CPUs, ROMs, and RAMs. Therefore, designing of the control boards is complicated and the manufacturing cost of the image forming apparatus is increased.

In addition, since the image processing unit and the engine controller of the conventional color image forming apparatus include respective independent processors, it may be necessary to include an additional interface circuit to interface between the processors.

To implement such an interface circuit, there may be a need to form a number of physical channels such as a command bus, an address bus, a status information bus, a data bus, and a control bus, each including a number of bit lines. In the color image forming apparatus, print data and control signals for print control need to be transmitted from the image processing unit to the print engine unit at a very high speed. However, it is difficult to perform high speed data transmission since the interface circuit uses a serial bus such that data transfer rate is low. Further, to implement such an interface, there may be a need to provide a number of input and output ports, connectors, and the like. This increases the cost of materials required to implement the interface, thereby increasing manufacturing costs of the image forming apparatus.

### SUMMARY OF THE INVENTION

Therefore, features and utilities of the present general inventive concepts provide a color image forming apparatus and a control board included in the same wherein a single processor integrally implements the functions of an image processing unit and an engine controller.

Additional features and utilities of the present general inventive concepts will be set forth in part in the description which follows and, in part, will be obvious from the description, or may be learned by practice of the present general inventive concepts.

In accordance with one feature and utilities of the present general inventive concepts, a color image forming apparatus includes an engine mechanism to perform color printing according to print data, and a control board including a processor to integrally perform an image processing process to convert the print data into image data readable by the engine mechanism and an engine control process to control the engine mechanism to perform color printing based on the image data.

The color image forming apparatus may be a Tandem color image forming apparatus including a plurality of exposure units and a plurality of developing units, and the processor of the control board may generate the image data and control the plurality of exposure units and the plurality of developing units based on the generated image data.

The control board may include at least one of memory parts including a flash memory, a RAM, and an electrically erasable programmable read-only memory (EEPROM) and the processor may include a microprocessor.

The microprocessor may be arranged within a preset distance from the memory parts.

The preset distance may be about 200 mm.

The control board may include a first connector to connect to a host computer that provides the print data and a second connector to connect to the engine mechanism.

The control board may have a polygonal shape having a plurality of sides and the first connector and the second connector may be arranged at different sides of the control board.

The second connector may be provided at a plurality of sides of the control board.

The processor may receive at least one horizontal synchronization signal from the plurality of exposure units and generate a plurality of image data based on the horizontal synchronization signal and output the plurality of generated image data to the plurality of exposure units.

In accordance with other features and utilities of the present general inventive concepts, a control board includes a processor to perform an image processing process to convert print data into image data readable by an engine mechanism that performs color printing according to the print data and an engine control process to control the engine mechanism to perform color printing based on the image data, a first memory to temporarily store data, a second memory to store a program to perform the image processing process and an engine control process, a first connector to connect to a host computer that provides the print data, and a second connector to connect to the engine mechanism.

The control board may have a polygonal shape and the first connector and the second connector may be arranged at different sides of the control board.

The second connector may be provided at a plurality of sides of the control board.

The processor may be arranged within a preset distance from the first and second memories.

The preset distance may be about 200 mm.

In accordance with other features and utilities of the present general inventive concepts, an image forming apparatus includes an engine mechanism to perform printing according to image data, and an integrated controller comprising a processor that integrally implements an image processing function to convert print data received from a host computer into the image data and an engine control function to control the engine mechanism to perform printing based on the image data.

The integrated controller is disposed on a control board, the control board including a first connector to connect to a source providing the print data and a second connector to connect to the engine mechanism, and the first connector and the second connector are arranged at different sides of the control board.

The second connector includes a plurality of second connectors provided on the sides of the control board that do not have the first connector, and the plurality of second connectors are connected to components of the engine mechanism that are closest to the respective second connectors.

The first connector carries signals that have higher frequency than signals carried by the second connector.

The processor has a plurality of sides to connect to block circuits on the integrated controller. The block circuits comprise at least one of memory parts including a flash memory, a random-access memory (RAM), and an electrically erasable programmable read-only memory (EEPROM).

The engine mechanism further includes a plurality of photosensitive drums, a plurality of exposure units to scan light onto the plurality of photosensitive drums, and a plurality of developing units to form developer images on the plurality of photosensitive drums. The image forming apparatus further includes photo sensors to generate a horizontal synchronization signal based on detection of light beams from the plurality of exposure units, wherein a plurality of image data for the plurality of exposure units are generated based on the horizontal synchronization signal.

In accordance with other features and utilities of the present general inventive concepts, an image forming apparatus includes an engine mechanism to perform printing according to image data, and a control board including a processor to perform an image processing function to convert print data received from a host computer into the image data and an engine control function to control the engine mechanism to perform printing based on the image data, and a first connector and a second connector provided at an opposing side of the first connector, wherein the first connector provides connection for a signal with a higher frequency than a signal provided via the second connector.

The first connector provides connection to a host device providing the print data and the second connector provides connection to components of the engine mechanism. The first connector includes at least one of a universal serial bus (USB) connector, a PSTN network connector and a wireless network connector.

In accordance with other features and utilities of the present general inventive concepts, an image forming apparatus includes an engine mechanism to perform printing according to image data, and a control board including a processor to perform an image processing function to convert print data received from a host computer into the image data and an engine control function to control the engine mechanism to perform printing based on the image data, and a first connector and a plurality of second connectors provided at different sides from the first connector, wherein the second connectors are connected to respective components of the engine mechanism closest to the respective second connectors.

The plurality of second connectors include a front second connector, a lower second connector and an upper second connector disposed at a front portion, a lower portion and an upper portion of the control board, respectively. The front second connector, the lower second connector and the upper second connector are connected to components of the engine mechanism in a front portion, a lower portion, and an upper portion of the image forming apparatus, respectively. The components of engine mechanism in the front portion of the image forming apparatus include a transfer unit, an electric charger and a photosensitive drum, the components of engine mechanism in the lower portion of the image forming apparatus include a developing unit and a laser scanning unit, and the components of engine mechanism in the upper portion of the image forming apparatus include a fixing unit.

The first connector is disposed to face an external surface of the image forming apparatus.

### BRIEF DESCRIPTION OF THE DRAWINGS

These and/or other features and utilities of the present general inventive concepts will become apparent and more readily appreciated from the following description of the embodiments, taken in conjunction with the accompanying drawings of which:

FIG. 1 is a block diagram schematically illustrating a color image forming apparatus according to an embodiment of the present general inventive concepts;

FIG. 2 is a cross-sectional view schematically illustrating the engine mechanism shown in FIG. 1, according to an embodiment of the present general inventive concepts;

FIGS. 3A and 3B are block diagrams schematically illustrating a control board array of the integrated controller shown in FIG. 1, according to an embodiment of the present general inventive concepts; and

FIG. 4 is a block diagram schematically illustrating an internal configuration of the processor shown in FIG. 3A, according to an embodiment of the present general inventive concepts.

### DETAILED DESCRIPTION OF THE PREFERRED EMBODIMENTS

Reference will now be made in detail to the embodiments of the present general inventive concepts, examples of which are illustrated in the accompanying drawings, wherein like reference numerals refer to like elements throughout. The embodiments are described below in order to explain the present general inventive concept while referring to the figures.

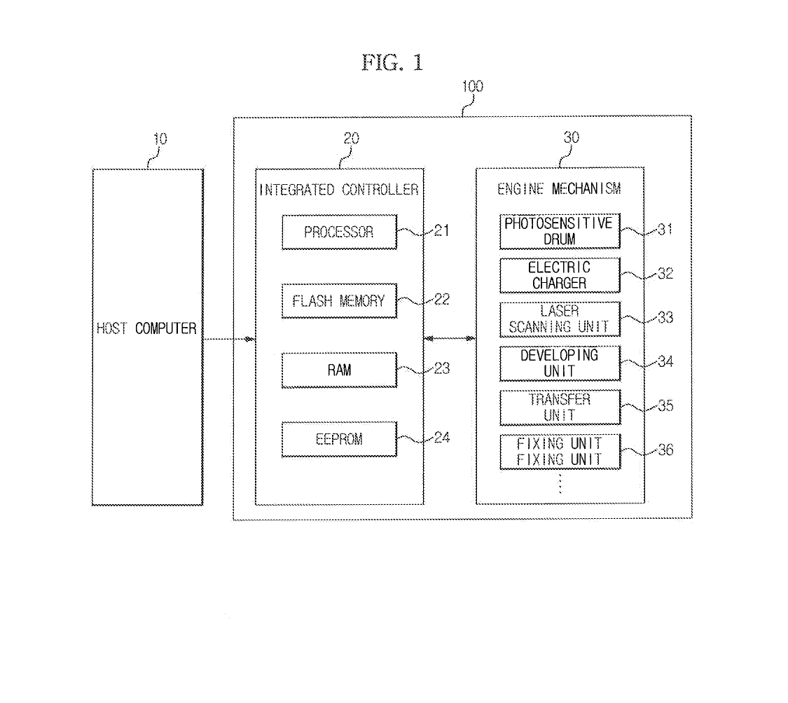

FIG. 1 illustrates a schematic configuration of a color image forming apparatus according to an embodiment of the present general inventive concepts.

As shown in FIG. 1, the color image forming apparatus 100 includes an integrated controller 20 and an engine mechanism 30 connected to the integrated controller 20. The integrated controller 20 converts print data provided from a host computer 10 into image data in a bitmap format and controls the operation of the engine mechanism 30 that performs color printing according to the image data. The host computer 10 may be an external device having connection to the integrated controller 20, such as, for example, a personal computer capable of transmitting print data to the color image forming apparatus 100.

The integrated controller 20 includes a processor 21, a flash memory 22, a RAM 23, and an electrically erasable programmable read-only memory (EEPROM) 24.

The processor 21 may be a single-chip processor, for example, a single microprocessor. The processor 21 may be constructed by integrating one processor for an image processing unit that converts print data into image data in a bitmap format and another processor for an engine controller that controls the operation of the engine mechanism 30 to perform printing of the image data. Thus, the processor 21 may be a single integrated processor that can perform both the image processing function and the engine control function.

The flash memory 22 may be a nonvolatile memory that may electrically erase and rewrite data, and stores a program to drive the processor 21 and the RAM 23. The flash memory 22 also stores programs to perform image processing and engine control functions.

The RAM 23 temporarily stores various data produced through execution of the programs associated with image processing and engine control functions and various data produced through processing of print data provided from the host computer 10.

The EEPROM 24 stores setting values to set operation states, control data of the engine control function, or control setting values or initial conditions of the image processing function. That is, the EEPROM 24 stores all initial values and set values that may be required for the image processing and engine control functions.

The engine mechanism 30 includes a photosensitive drum 31, an electric charger 32, a Laser Scanning Unit (LSU) 33, a developing unit 34, a transfer unit 35, and a fixing unit 36. The electric charger 32 electrically charges the photosensitive drum 31. The laser scanning unit 33 scans a laser beam corresponding to image data onto the photosensitive drum 31 to form an electrostatic latent image on the photosensitive drum 31. The developing unit 34 provides a developer to the photosensitive drum 31 with the electrostatic latent image formed thereon, so as to form a developer image on the photosensitive drum 31. The transfer unit 35 transfers the developer image formed on the photosensitive drum 31 to a recording medium such as a sheet of paper. The fixing unit 36 fuses and bonds the developer image transferred to the recording medium by applying heat and pressure.

The color image forming apparatus may be classified into a multi-path type and a single-path type according to a printing scheme employed. The multi-path type has a low print speed of printing since it repeats transfer of the developing image for each color one at a time, thus performing the transfer the same number of times as the number of developer colors, although the multi-path type may achieve a small product size since it has a simple structure. The single-path type, which is also referred to as a Tandem type, employs a mechanism that transfers color developers of different colors at once to achieve the same print speed as black and white printing.

The Tandem color image forming apparatus may include, for example, four photosensitive drums and four exposure units, for four colors schemes. Alternatively, the Tandem color image forming apparatus may also include one exposure unit including a plurality of exposure sections, for example, four or six exposure sections for four or six color schemes. Specifically, the Tandem color image forming apparatus includes a number of exposure units corresponding to the number of photosensitive drums to transfer color developers at once. Here, the four photosensitive drums correspond respectively to the four colors, including yellow, magenta, cyan, and black. Each exposure unit scans light to a corresponding photosensitive drum to form an electrostatic latent image desired by the user on the photosensitive drum.

Reference will now be made to a case where the color image forming apparatus is a Tandem color image forming apparatus according to an embodiment of the present general inventive concepts.

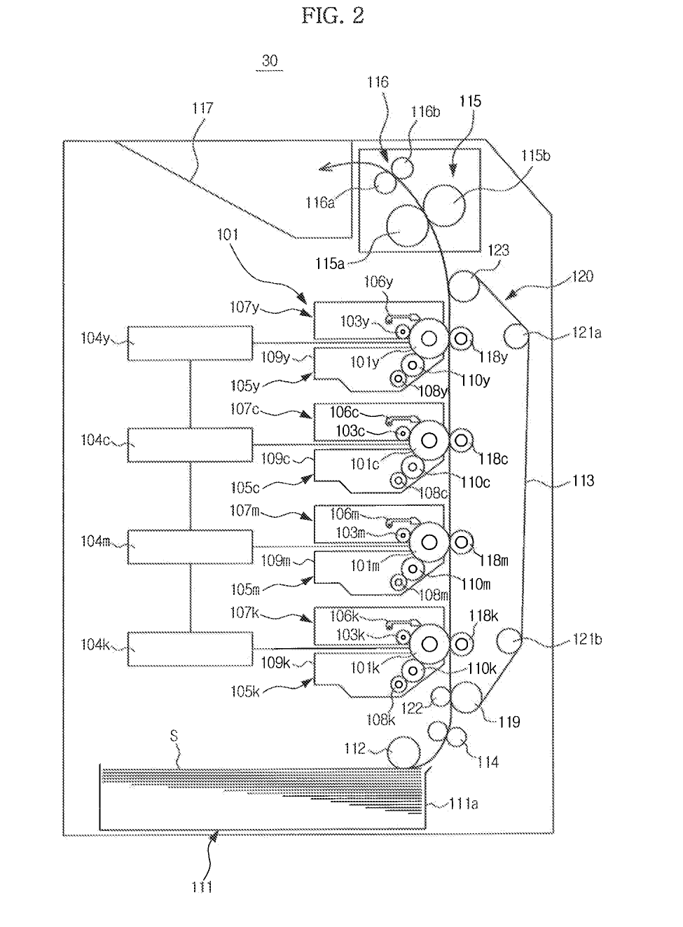

FIG. 2 schematically illustrates an exemplary embodiment of the engine mechanism 30 shown in FIG. 1.

As shown in FIG. 2, the engine mechanism 30 includes a paper feed unit 111, an image forming unit 101, a transfer unit 120, a fixing unit 115, and a paper discharge unit 116.

The paper feed unit 111 feeds a recording medium S such as a print medium or paper and includes a paper feed cassette 111a, a pickup roller 112, and a Regi roller 114. The paper feed cassette 111a is mounted at the bottom of a body M of the apparatus. The pickup roller 112 picks up and conveys a recording medium S stacked in the paper feed cassette 111a to the Regi roller 114.

The image forming unit 101 is provided above the paper feed unit 111 and forms developer images of specific ones of the colors, black K, magenta M, cyan C, or yellow Y, on the recording medium S.

The image forming unit 101 includes photosensitive drums 101k, 101m, 101c, and 101y. The photosensitive drums 101k, 101m, 101c, and 101y are sequentially arranged at specific intervals in a vertical direction from bottom to top of FIG. 2 at positions opposite from a transfer belt 113 of the transfer unit 120. The photosensitive drums 101k, 101m, 101c, and 101y are in contact with the transfer belt 113 under certain pressure by transfer devices 118k, 118m, 118c, and 118y of the transfer unit 120 to form nips and are rotated counterclockwise by gear trains that receive motive power from a drive motor.

In addition, electric chargers 103k, 103m, 103c, and 103y, laser scanning units 104k, 104m, 104c, and 104y, developing units 105k, 105m, 105c, and 105y, and the like are arranged around the photosensitive drums 101k, 101m, 101c, and 101y.

The electric chargers 103k, 103m, 103c, and 103y include respective electric charger rollers, and are in contact with surfaces of the photosensitive drums 101k, 101m, 101c, and 101y. The electric chargers 103k, 103m, 103c, and 103y receive a charging bias voltage from a power supply to generate a charge potential on the surfaces of the photosensitive drums 101k, 101m, 101c, and 101y. For example, a charge potential of about −600V may be generated on the surfaces of the photosensitive drums 101k, 101 m, 101c, and 101y when the polarity of each developer is negative.

The laser scanning units 104k, 104m, 104c, and 104y emit laser beams onto the surfaces of the photosensitive drums 101k, 101m, 101c, and 101y charged by the electric chargers 103k, 103m, 103c, and 103y according to image signals received from a computer (e.g. the host computer 10), scanner, or the like to form electrostatic latent images having a potential level lower than the charged potential, for example, a potential level of about −50V. A detailed description of the configurations of the laser scanning units 104k, 104m, 104c, and 104y is omitted herein since the configurations of the laser scanning units 104k, 104m, 104c, and 104y are known in the art.

The developing units 105k, 105m, 105c, and 105y attach developers of corresponding colors (e.g. black, magenta, cyan and yellow) to the surfaces of the photosensitive drums 101k, 101m, 101c, and 101y including electrostatic latent images formed thereon to develop developer images corresponding to those colors. The developing units 105k, 105m, 105c, and 105y include developer containers 109k, 109m, 109c, and 109y, developing rollers 110k, 110m, 110c, and 110y, and developer supply rollers 108k, 108m, 108c, and 108y, respectively.

The developer containers 109k, 109m, 109c, and 109y respectively contain black K, magenta M, cyan C, and yellow Y developers having a specific polarity, for example, a negative polarity.

The developing rollers 110k, 110m, 110c, and 110y rotate while being engaged with the photosensitive drums 101k, 101m, 101c, and 101y to attach developers to electrostatic latent images on the photosensitive drums 101k, 101m, 101c, and 101y to develop the developer images. The developing rollers 110k, 110m, 110c, and 110y are arranged near the surfaces of the photosensitive drums 101k, 101m, 101c, and 101y and are rotated clockwise by power transfer gears coupled to the gear trains that drive the photosensitive drums 101k, 101m, 101c, and 101y. The developing rollers 110k, 110m, 110c, and 110y receive, from the power supply, a predetermined developing bias voltage (for example, about −250V) that is 100-400V lower than that of the developer supply rollers 108k, 108m, 108c, and 108y.

The developer supply rollers 108k, 108m, 108c, and 108y supply respective developers to the developing rollers 110k, 110m, 110c, and 110y using a potential difference between the developer supply rollers 108k, 108m, 108c, and 108y and the developing rollers 110k, 110m, 110c, and 110y. The developer supply rollers 108k, 108m, 108c, and 108y may be arranged in contact with lower lateral portions of the developing rollers 110k, 110m, 110c, and 110y to form nips. Black K, magenta M, cyan C, and yellow Y developers contained respectively in the developer containers 109k, 109m, 109c, and 109y are conveyed into lower spaces between the developer supply rollers 108k, 108m, 108c, and 108y and the developing rollers 110k, 110m, 110c, and 110y through agitators in the developer containers 109k, 109m, 109c, and 109y.

The developer supply rollers 108k, 108m, 108c, and 108y receive, from the power supply, a predetermined developer supply bias voltage (for example, about −500V) that is 100-400V lower than that of the developer supply rollers 108k, 108m, 108c, and 108y. Developers conveyed into the lower spaces between the developer supply rollers 108k, 108m, 108c, and 108y and the developing rollers 110k, 110m, 110c, and 110y are charged by the developer supply rollers 108k, 108m, 108c, and 108y to be attached to the developing rollers 110k, 110m, 110c, and 110y and then to move into the nips between the developer supply rollers 108k, 108m, 108c, and 108y and the developing rollers 110k, 110m, 110c, and 110y.

Cleaning units 107k, 107m, 107c, and 107y remove waste developers remaining on the surfaces of the photosensitive drums 101k, 101m, 101c, and 101y after the photosensitive drums 101k, 101m, 101c, and 101y are rotated one revolution. The cleaning units 107k, 107m, 107c, and 107y include photosensitive drum cleaning blades 106k, 106m, 106c, and 106y, respectively to remove waste developers from the photosensitive drums 101k, 101m, 101c, and 101y.

The transfer unit 120 serves to transfer developer images formed on the photosensitive drums 101k, 101m, 101c, and 101y to the recording medium S and includes the transfer belt 113 and the transfer devices 118k, 118m, 118c, and 118y.

The transfer belt 113 serves to convey the recording medium S. A pressure device 122 that presses the transfer belt 113 against the driven roller 119 is provided on the transfer belt 113 at an upstream side of the transfer belt 113 in a medium conveyance direction (as shown in a lower part of FIG. 2). A predetermined bias voltage is applied to the pressure device 122. The recording medium S is conveyed to the transfer belt 113 while being in close contact with the transfer belt 113 through a Regi roller 114.

The transfer belt 113 is mounted so as to be rotated in a medium conveyance direction by a plurality of rotating rollers including a driving roller 123, two tension rollers 121a and 121b, and the driven roller 119. For example, the driving roller 123 may be powered by a motor to rotate the driving roller 123, which moves the transfer belt 113 in a direction of the rotation of the driving roller 123, thereby rotating the driven roller 119 as well as the two tension rollers 121a and 121b. The tension rollers 121a and 121b may provide, for example, sufficient tension to the transfer belt 113 to enable the transfer belt 113 to stay on the driving roller 12 and the driven roller 119.

The transfer devices 118k, 118m, 118c, and 118y may be image transfer voltage applying members that apply image transfer bias voltages to the transfer belt 113. The transfer devices 118k, 118m, 118c, and 118y are arranged inside the transfer belt 113 so as to press the transfer belt 113 against the photosensitive drums 101k, 101m, 101c, and 101y with a certain pressure. The transfer devices 118k, 118m, 118c, and 118y receive an image transfer bias voltage from the power supply that is controlled by the integrated controller 20.

The fixing unit 115 fixes the developer images transferred to the recording medium S and includes a heating roller 115a and a pressure roller 115b. The heating roller 115a includes an internal heater to fix the developer images to the recording medium S through high temperature heat.

The pressure roller 115b is mounted so as to be pressed against the heating roller 115a by an elastic pressure member to depress the recording medium S.

The paper discharge unit 116 serves to discharge the recording medium S with the developer images fixed thereon to the discharge tray 117 and includes a paper discharge roller 116a and a backup roller 116b. The discharge roller 116a and the backup roller 116 rotate to convey the recording medium S toward the discharge tray 117.

In the engine mechanism 30 having the above structure, the recording medium S is moved while remaining in contact with the transfer belt 113 and the images transferred to the recording medium S from the photosensitive drums 101k, 101m, 101c, and 101y are superimposed to one another as the recording medium S passes by the photosensitive drums 101k, 101m, 101c, and 101y and the superimposed image is then fixed to the recording medium S while the recording medium S passes through the fixing unit 115. That is, the above engine mechanism 30 develops, transfers, and fixes color images on a sheet of paper at once by allowing the sheet of paper to move along the single paper path only once.

The following is a description of a procedure in which the integrated controller 20 of the color image forming apparatus controls the engine mechanism 30 having the above configuration according to an embodiment of the present general inventive concepts.

First, when a sheet of paper fed from the paper feed cassette 111a arrives at a predetermined position, a Regi sensor is turned on to detect such arrival. Then, the integrated controller 20 causes the first laser scanning unit 104k to initiate scanning of video image data of the first color (i.e., K color) after a predetermined time delay from when the Regi sensor is turned on.

Then, the integrated controller 20 causes the second laser scanning unit 104m to initiate scanning of video image data when the sheet of paper has advanced a predetermined distance since the second laser scanning unit 104m is spaced from the first laser scanning unit 104k at the predetermined distance. For example, the integrated controller 20 may cause the scanning by the second laser scanning unit 104m when the sheet of paper has advanced sufficient distance to become close to the second photosensitive drum 101m.

Then, the integrated controller 20 sequentially activates the third laser scanning unit 104c and the fourth laser scanning unit 104y in the same manner as described above to superimpose the corresponding color images to perform color printing.

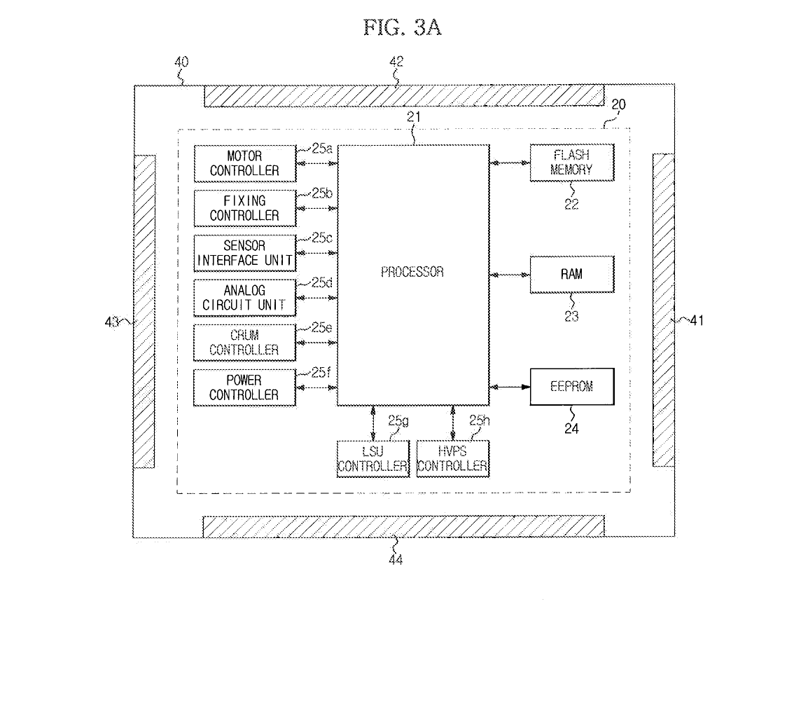

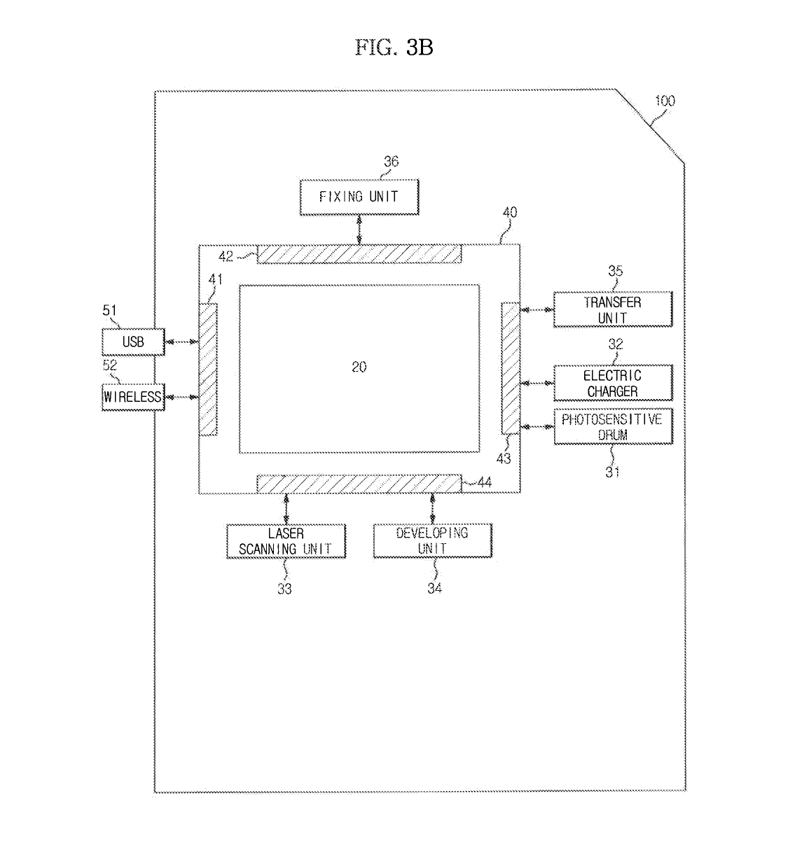

FIGS. 3A and 3B illustrate exemplary embodiments of a control board array of the integrated controller 20 shown in FIG. 1.

As shown in FIG. 3A, the integrated controller 20 includes a processor 21, a flash memory 22, a RAM 23, and an EEPROM 24.

The processor 21 may be a single microprocessor including a single System on Chip (SoC). The processor 21 is constructed so as to integrally perform an image processing function that converts print data provided from the host computer 10 into image data in a bitmap format and an engine control function that controls the engine mechanism 30 to form a corresponding image on a recording medium (e.g., paper) according to the image data.

The integrated controller 20 may include a motor controller 25a, a fixing controller 25b, a sensor interface unit 25c, an analog circuit unit 25d, a Customer Replacement Unit Memory (CRUM) 25e, a power controller 25f, an LSU controller 25g, and a high voltage power supply (HVPS) controller 25h.

The integrated controller 20 having these components may be provided on a control board 40 that has a polygonal shape having a plurality of sides (for example, a rectangular shape).

The control board 40 includes a first connector 41 for data communication with the host computer 10, the public switched telephone network (PSTN), and a wireless network and second connectors 42, 43, and 44 for data communication with the engine mechanism 30.

That is, the processor 21, which may include a single System-On-Chip (SoC) chip, is provided in the control board 40, block circuits 22-25h are provided around the processor 21 and connected to the processor 21, and the first connector 41 is provided at one side of the control board 40.

In addition, the second connectors 42, 43, and 44 are provided at the three other sides of the control board 40.

Among the block circuits 22-25h, the block circuits 22-24 may be provided at the first side of the processor 21, the block circuits 25a-25f may be provided at the second side of the processor 21, and the block circuits 25g and 25h may be provided at the third side of the processor 21. For example, the flash memory 22, the RAM 23, and the EEPROM 24 may be provided at the right side of the processor 21, the motor controller 25a, the fixing controller 25b, the sensor interface unit 25c, the analog circuit unit 25d, the CRUM controller 25e, and the power controller 25f may be provided at the left side of the processor 21, the LSU controller 25g and the HVPS controller 25h may be provided at the lower side of the processor 21, as illustrated in FIG. 3A.

For example, in the case where the first connector 41 of the control board 40 is connected to the host computer 10 or the like while extending vertically in the body of the color image forming apparatus 100, the components of the engine mechanism 30 provided at the upper side of the body are connected to the second connector 42, the components thereof provided at the front side of the body are connected to the second connector 43, and the components thereof provided at the lower side of the body are connected to the second connector 44.

The first connector 41 of the control board 40 may be arranged so as to face an external surface of the system to allow the user to easily connect the color image forming apparatus to the host computer 10. The first connector 41 may include a universal serial bus (USB) connector, a PSTN network connector, or a wireless network connector.

FIG. 3B illustrates an example of the control board 40 connected to various components of the color image forming apparatus 100. As shown in FIG. 3B, the color image forming apparatus 100 may include the control board 40 having the integrated controller 20 as well as the first connector 41 and the second connectors 42, 43 and 44. The first connector 41 may face the back of the color image forming apparatus 100 and may be connected to a USB connector 51 and a wireless network connector 52, which provide connection to the host computer 10 or any other source for the print data. The second connector 42 may be connected to the fixing unit 36 as the fixing unit 36 is provided at the upper side of the image forming apparatus 100. The second connector 43 may be connected to the components provided at the front side of the image forming apparatus 100, such as the transfer unit 35, the electric charger 32 or the photosensitive drum 31. Further, because the laser scanning unit 33 and the developing unit 34 may be located towards the lower (and back) side of the image forming apparatus 100, these components may be connected to the second connector 44.

The signals transmitted through the first connector 41 may have frequencies of different magnitudes from the signals transmitted through the second connectors 42, 43 and 44. Thus, for example, if the first connector 41 that is connected to the host computer 10 or the like is located at the same side as the second connectors 42, 43, and 44 that are connected to the engine mechanism 30, signals transmitted through the first connector 41 may interfere with low frequency signals transmitted through the second connectors 42, 43, and 44 since the signals transmitted through the first connector 41 have relatively high frequencies. Accordingly, the first connector 41 is arranged at a side of the control board 40 different from the second connectors 42, 43, and 44 to improve system stability.

By dividing the second connector into the three connectors 42, 43, and 44, it may be possible to form a harness path to decrease the length of connection signal lines and to reduce signal interference between the signal lines. Here, since the second connectors 42, 43, and 44 are provided at the upper side, the front side, and the lower side of the control board 40, the components of the engine mechanism 30 may be connected to the second connectors 42, 43, and 44 spaced apart at minimum distances so as to have characteristics of being robust to external noise.

Main circuit parts provided at the sides of the control board 40 are arranged at positions close to the four sides of the processor 21. Here, the positions of high speed signal lines, clock lines, or analog control signal lines may be arranged taking into consideration their patterns and arrangement priorities.

Specifically, the memory parts, i.e., the flash memory 22, the RAM 23, and the EEPROM 24, may be arranged at positions nearest to the processor 21 since they have many address, data, and control signal lines. In addition, to maintain good signal levels, there may be a need to maintain a small distance between the processor 21 and the memory parts 22, 23, and 24 since they have high operating frequencies.

That is, pattern signal lines cause signal loss and distortion if the pattern signal lines have high resistance. When various information or image data is read from or written to a volatile memory, signal distortion may cause incorrect reading or writing, thereby causing malfunction of the system. When the system starts up, a program stored in the nonvolatile memory is read and stored in the volatile memory. Here, if data has not been correctly read from the nonvolatile memory, the program may fail to be activated, thereby causing system malfunction.

Thus, if the distances between the processor 21 and the memory parts 22, 23, and 24 are minimized and thus, for example, maintained within about 0 to about 200 mm, it may be possible to prevent system malfunction, to reduce noise, and to acquire correct addresses and data signal waveforms. Acquisition of correct data signal waveforms stabilizes the system.

Here, for example, the lengths of signal lines between the processor 21 and the memory parts 22, 23, and 34 are limited within about 200 mm since, for signal lines of less than about 200 mm, it may be possible to compensate for signal distortion using parts such as filters that may reduce signal distortion.

Since the integrated controller 20 is implemented using a single processor 21 as described above, data exchange between the image processing function and the engine control function may be achieved without additional interface circuits. Therefore, it may be possible to increase data transfer rate and to reduce space and part costs by those required to construct additional interface circuits.

In addition, since the integrated controller 20 may only need to include one memory 21, one RAM 22, and one EEPROM 23 to perform the image processing function and the engine control function, it may be possible to further reduce space and manufacturing costs. That is, since it may be possible to minimize circuit elements required to implement the image processing function and the engine control function, it may be possible not only to reduce manufacturing costs but also to reduce the size of the control board 40.

The engine mechanism 30 of the Tandem color image forming apparatus may include a plurality of laser scanning units 104k, 104m, 104c, and 104y and a plurality of developing units 105k, 105m, 105c, and 105y.

The laser scanning units 104k, 104m, 104c, and 104y scan light beams to the photosensitive drums 101k, 101m, 101c, and 101y according to a plurality of video image data simultaneously output by the processor 21. Here, when the video image data will be scanned is determined based on a corresponding horizontal synchronization signal nHSYNC. Horizontal synchronization signals nHSYNC are signals that photodiode sensors located at edges of polygonal mirrors provided to the laser scanning units 104k, 104m, 104c, and 104y generate by detecting laser beams that laser diodes of the laser scanning units 104k, 104m, 104c, and 104y continuously emit while the polygonal mirrors rotate.

The Tandem color image forming apparatus may use one or a plurality of nHSYNC signals. When the Tandem color image forming apparatus uses one nHSYNC signal, the laser scanning units 104k, 104m, 104c, and 104y include only one polygonal mirror. If four laser beams of the laser scanning units 104k, 104m, 104c, and 104y are scanned using one motor, one horizontal synchronization signal may be generated.

In the case where one horizontal synchronization signal is used, video image data of each color is output with a time difference from the nHSYNC signal according to a corresponding time value set in a register.

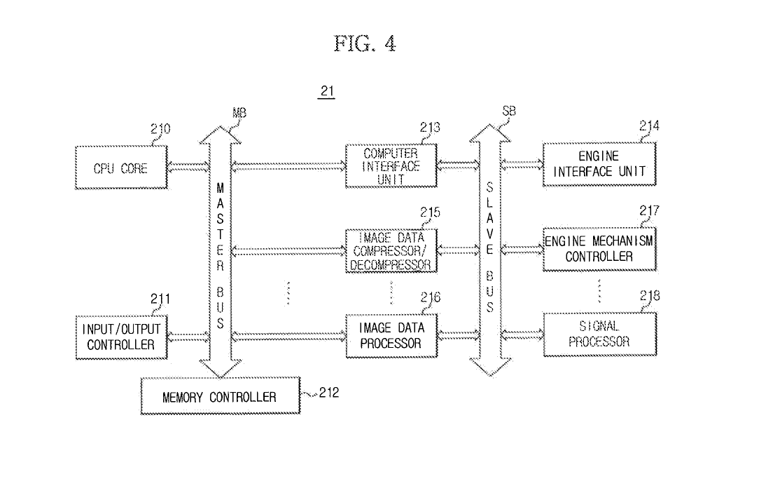

FIG. 4 schematically illustrates an internal configuration of the processor shown in FIG. 3A.

As shown in FIG. 4, the processor 21 of the integrated controller 20 includes a CPU core 210, an input/output controller 211, a memory controller 212, a computer interface unit 213, an engine interface unit 214, an image data compressor/decompressor 215, an image data processor 216, an engine mechanism controller 217, and a signal processor 218.

The CPU core 210 performs overall control of the components of the processor 21.

The input/output controller 211 receives or outputs signals, such as an access request, data signals, and various other commands, etc.

The memory controller 212 controls operations to access, or to read data from, or to write data to a flash memory, a RAM, an EEPROM (e.g. the flash memory 22, the RAM 23, the EEPROM 24), or the like according to an access request from the input/output controller 211. The memory controller 212 also serves to temporarily store data and to transfer data between the input/output controller 211 and other components including the processor 21 and the memory parts such as the flash memory 22, and the RAM 23.

The computer interface unit 213 may be provided in the processor 21 and may be connected between the host computer 10 and the processor 21 to interface input and output signals therebetween.

The engine interface unit 214 may be provided in the processor 21 and may be connected between the processor 21 and the engine mechanism 30 to interface input and output signals therebetween.

The image data compressor/decompressor 215 compresses or decompresses image data.

The image data processor 216 may include an image data generator to generate image data and a pattern generator.

The engine mechanism controller 217 serves to control formation of electrostatic latent images on photosensitive drums or control drive motors of the color image forming apparatus according to the image data generated by the image data processor 216.

The signal processor 218 may include an analog-digital converter (ADC) and a digital-analog converter (DAC) to perform conversion between an analog signal and a digital signal.

The components of the processor 21 exchange information through a master bus (MB) and a slave bus (SB). Thus, for example, the CPU core 210 and the input/output controller 21 may be connected to the MB, which is also connected to the memory controller 212. Also, the engine interface unit 214, the engine mechanism controller 217 and the signal processor 218 may be connected to the SB. Further, the computer interface unit 213, the image data compressor/decompressor 215 and the image data processor 216 may be connected to both the MB and the SB.

The processor 21 constructed as described above performs image processing to convert print data into image data in a bitmap format and controls operations of the engine mechanism 30 based on the converted image data.

The integrated controller 20 formed on the control board 40 performs an engine control function in the following manner. First, when a sheet of paper has been picked up from the paper feed cassette 111a to perform printing, the integrated controller 20 scans and develops an image on the first photosensitive drum 101k of the first developing unit 105k at an appropriate time upon arrival of a leading edge of the sheet of paper at the first developing unit 105k. When the sheet of paper is located at the first developing unit 105k, the integrated controller 20 applies a first positive image transfer voltage to the first transfer device 118k provided on the transfer belt 113. This produces a potential difference between the first transfer device 118k and a negatively charged developer image developed on the first photosensitive drum 101k of the first developing unit 105k to transfer the negatively charged developer image to the sheet of paper from the first photosensitive drum 101k.

Since, at this point, the sheet of paper is located between the first photosensitive drum 101k and the first transfer device 118k, the developed developer image is attached to the surface of the sheet of paper. Here, the second, third, and fourth developing units 105m, 105c, and 105y arranged above the first developing unit 105k do not perform their developing processes while the first developing unit 105k is in operation. As the leading edge of the sheet of paper is fed and moved upward by the pickup roller 112, developing bias and transfer bias voltages are sequentially applied to the four developing units 105k, 105m, 105c, and 105y. That is, each of the developing units 105k, 105m, 105c, and 105y performs exposure, development, and transfer processes when the leading edge of the sheet of paper arrives at each of the developing units 105k, 105m, 105c, and 105y at a corresponding color development time.

Here, upon receiving a horizontal synchronization signal Hsync, the processor 21 of the integrated controller 20 stores print data of each color in the RAM 23 after performing image rendering of the print data. Then, when the fed sheet of paper is to be developed, the processor 21 accesses the rendered data stored in the RAM 23 and outputs the data through video signal lines of the laser scanning units 104k, 104m, 104c, and 104y. Then, the laser scanning units 104k, 104m, 104c, and 104y receive the corresponding data and perform exposure operations by scanning laser beams to the photosensitive drums 101k, 101m, 101c, and 101y of the developing units 105k, 105m, 105c, and 105y through their laser diodes.

Among the developing units 105k, 105m, 105c, and 105y, the first developing unit 105k first performs an exposure operation since the fed sheet of paper first enters the first developing unit 105k. Here, while the first laser scanning unit 104k performs an exposure operation by exposing the photosensitive drum 101k to light (e.g., a laser beam) based on image data, the other laser scanning units 104m, 104c, and 104y do not receive the image data while motors of the laser scanning units 104m, 104c, and 104y are rotating and thus the photosensitive drums 101m, 101c, and 101y are not exposed to light by the laser scanning units 104m, 104c, and 104y.

When the sheet of paper is further fed after the photosensitive drum 101k of the first developing unit 105k is exposed to light, the sheet of paper arrives at the second developing unit 105m. As in the first developing unit 105k, the processor 21 of the integrated controller 20 stores data of the next color M in the RAM 23 after performing image rendering on the data upon receiving a horizontal synchronization signal HSync of the second laser scanning unit 104m. Then, when the time to develop the fed sheet of paper at the second developing unit 105m is reached, the processor 21 accesses the rendered data stored in the RAM 23 and outputs the data through a video signal line of the second laser scanning unit 104m to scan a laser beam to the photosensitive drum 101m of the second developing unit 105m. Then, the third and fourth developing units 105c and 105y sequentially perform developing operations in the same manner.

The processor 21 of the integrated controller 20 performs color printing by sequentially forming first, second, third, and fourth developed color images in the above manner.

As is apparent from the above description, since the functions of an image processing unit and an engine controller are integrally implemented by a single processor on a control board, it may be possible to eliminate circuits associated with an interface between the image processing unit and the engine controller, the circuits being needed when the image processing unit and the engine controller are separately located, and it may also be possible to reduce the number of ROMs and RAMs. Thus, it may be possible to reduce manufacturing costs of the image forming apparatus and to efficiently design the control board.

In addition, since the functions of the image processing unit and the engine controller are integrally implemented by the single processor on the control board, it may be possible to perform high speed data transfer from the image processing block to the engine control block, it may be possible to increase resistance to external or internal noise, it may be possible to enable data transmission without an interface circuit for interfacing between the image processing unit and the engine controller, and it may be possible to reduce control board design time since parts other than the processor may be reused once the process is redesigned.

Although a few embodiments of the present general inventive concept has been shown and described, it would be appreciated by those skilled in the art that changes may be made in these embodiments without departing from the principles and spirit of the general inventive concept, the scope of which is defined in the claims and their equivalents.

What is claimed is:

1. A color image forming apparatus comprising:
an engine mechanism to perform color printing according to print data; and
a control board comprising a processor to integrally perform an image processing process to convert the print data into image data readable by the engine mechanism and an engine control process to control the engine mechanism to perform color printing based on the image data.

2. The color image forming apparatus according to claim 1, wherein:
the color image forming apparatus is a Tandem color image forming apparatus comprising a plurality of exposure units and a plurality of developing units, and
the processor of the control board generates the image data and controls the plurality of exposure units and the plurality of developing units based on the generated image data.

3. The color image forming apparatus according to claim 2, wherein:
the control board comprises at least one of memory parts comprising a flash memory, a random-access memory (RAM), and an electrically erasable programmable read-only memory (EEPROM), and
the processor comprises a microprocessor.

4. The color image forming apparatus according to claim 3, wherein the microprocessor is arranged within a preset distance from the memory parts.

5. The color image forming apparatus according to claim 4, wherein the preset distance is about 200 mm.

6. The color image forming apparatus according to claim 4, wherein the control board comprises a first connector to connect to a host computer that provides the print data and a second connector to connect to the engine mechanism.

7. The color image forming apparatus according to claim 6, wherein the control board has a polygonal shape having a plurality of sides and the first connector and the second connector are arranged at different sides of the control board.

8. The color image forming apparatus according to claim 7, wherein the second connector is provided at a plurality of sides of the control board.

9. The color image forming apparatus according to claim 2, wherein the processor receives at least one horizontal synchronization signal from the plurality of exposure units, generates a plurality of image data based on the horizontal synchronization signal, and outputs the plurality of generated image data to the plurality of exposure units.

10. A control board comprising:
a processor to perform an image processing process to convert print data into image data readable by an engine mechanism that performs color printing according to the print data and an engine control process to control the engine mechanism to perform color printing based on the image data;
a first memory to temporarily store data;
a second memory to store a program to perform the image processing process and the engine control process;
a first connector to connect to a host computer that provides the print data; and
a second connector to connect to the engine mechanism.

11. The control board according to claim 10, wherein:
the control board has a polygonal shape, and the first connector and the second connector are arranged at different sides of the control board.

12. The control board according to claim 11, wherein the second connector is provided at a plurality of sides of the control board.

13. The control board according to claim 10, wherein the processor is arranged within a preset distance from the first and second memories.

14. The control board according to claim 13, wherein the preset distance is about 200 mm.

15. An image forming apparatus, comprising
an engine mechanism to perform printing according to image data; and
an integrated controller comprising a processor that integrally implements an image processing function to convert print data received from a host computer into the image data and an engine control function to control the engine mechanism to perform printing based on the image data.

16. The image forming apparatus of claim 15, wherein:
the integrated controller is disposed on a control board, the control board including a first connector to connect to a source providing the print data and a second connector to connect to the engine mechanism, and
the first connector and the second connector are arranged at different sides of the control board.

17. The image forming apparatus of claim 17, wherein:
the second connector includes a plurality of second connectors provided on the sides of the control board that do not have the first connector, and
the plurality of second connectors are connected to components of the engine mechanism that are closest to the respective second connectors.

18. The image forming apparatus of claim 15, wherein the first connector carries signals that have higher frequency than signals carried by the second connector.

19. The image processing apparatus of claim 15, wherein the processor has a plurality of sides to connect to block circuits on the integrated controller.

20. The image forming apparatus of claim 19, wherein the block circuits comprise at least one of memory parts including a flash memory, a random-access memory (RAM), and an electrically erasable programmable read-only memory (EEPROM).

21. The image forming apparatus of claim 15, wherein the engine mechanism further comprises:
a plurality of photosensitive drums;
a plurality of exposure units to scan light onto the plurality of photosensitive drums; and
a plurality of developing units to form developer images on the plurality of photosensitive drums.

22. The image forming apparatus of claim 21, further comprising photo sensors to generate a horizontal synchronization signal based on detection of light beams from the plurality of exposure units, wherein a plurality of image data for the plurality of exposure units are generated based on the horizontal synchronization signal.

23. An image forming apparatus, comprising
an engine mechanism to perform printing according to image data; and
a control board including:
a processor to perform an image processing function to convert print data received from a host computer into the image data and an engine control function to control the engine mechanism to perform printing based on the image data; and
a first connector and a second connector provided at an opposing side of the first connector, wherein the first connector provides connection for a signal with a higher frequency than a signal provided via the second connector.

24. The image forming apparatus of claim 23, wherein the first connector provides connection to a host device providing the print data and the second connector provides connection to components of the engine mechanism.

25. The image forming apparatus of claim 23, wherein the first connector includes at least one of a universal serial bus (USB) connector, a PSTN network connector and a wireless network connector.

26. An image forming apparatus, comprising
an engine mechanism to perform printing according to image data; and
a control board including:
a processor to perform an image processing function to convert print data received from a host computer into the image data and an engine control function to control the engine mechanism to perform printing based on the image data; and
a first connector and a plurality of second connectors provided at different sides from the first connector, wherein the second connectors are connected to respective components of the engine mechanism closest to the respective second connectors.

27. The image forming apparatus of claim 26, wherein the plurality of second connectors include a front second connector, a lower second connector and an upper second connector disposed at a front portion, a lower portion and an upper portion of the control board, respectively.

28. The image forming apparatus of claim 27, wherein the front second connector, the lower second connector and the upper second connector are connected to components of the engine mechanism in a front portion, a lower portion, and an upper portion of the image forming apparatus, respectively.

29. The image forming apparatus of claim 28, wherein:
the components of engine mechanism in the front portion of the image forming apparatus include a transfer unit, an electric charger and a photosensitive drum,
the components of engine mechanism in the lower portion of the image forming apparatus include a developing unit and a laser scanning unit, and
the components of engine mechanism in the upper portion of the image forming apparatus include a fixing unit.

30. The image forming apparatus of claim 26, wherein the first connector is disposed to face an external surface of the image forming apparatus.
